(19) United States
(12) Patent Application Publication
(10) Pub. No.: US 2009/0178625 A1
(43) Pub. Date: Jul. 16, 2009

(54) USE OF A CLOTH

(75) Inventors: Adrian Watson, Leicestershire (GB); Sally Beyer, Leicestershire (GB); Paul Richard Heaton, Leicestershire (GB)

Correspondence Address: FULBRIGHT & JAWORSKI L.L.P, 2200 ROSS AVENUE, SUITE 2800, DALLAS, TX, 75201-2784, US

(73) Assignee: Mars UK Limited, Slough (GB)

(21) Appl. No.: 11/721,527

(22) PCT Filed: Dec. 16, 2005
(86) PCT No.: PCT/GB05/04868

§ 371 Date: Dec. 13, 2007

(30) Foreign Application Priority Data
Dec. 17, 2004 (GB) 0427736.4

(51) Int. Cl. A01K 13/00

(52) U.S. Cl. 119/601; 119/600

(57) ABSTRACT

The present invention relates to the use of an electrostatically charged cloth for reducing the allegenicity of an animal. It also relates to a method of reducing the allegenicity of an animal, using such a cloth. It also relates to an animal grooming device comprising an electrostatically charged cloth.

### CROSS-REFERENCE TO RELATED APPLICATIONS

This application is the National Stage of International Application No. PCT/GB2005/004868 filed Dec. 15, 2005 which claims priority to Great Britain Application No. GB 0427736.4 filed Dec. 17, 2004.

### TECHNICAL FIELD

The present invention relates to the use of an electrostatically charged cloth for reducing the allergenicity of any animal. It also relates to a method of reducing the allergenicity of an animal, using such a cloth. It also relates to an animal grooming device comprising an electrostatically charged cloth.

### BACKGROUND OF THE INVENTION

Approximately 2-15% of the world's population and as many as 26% of the population of the UK is allergic to companion animals. Being allergic to companion animals is one of the most common reasons for not owing a pet.

Symptoms of allergy to animals are sneezing, coughing, itchy eyes, wheezing and rashes. In some people, the symptoms can be relatively mild and bearable. However, in others, it is impossible to even briefly visit a house where an animal is kept without displaying an allergic reaction to the animal. The allergic reaction can have a more serious clinical result, such as an asthma attack, which may lead to a need for medical attention or even long term health problems.

The main cause of allergy in cats is thought to be the Fel-d1 protein, secreted by the sebaceous glands of cats. When the cat washes and licks itself, the protein is distributed over the hair of its coat. Therefore, the allergen is easily spread when the cat loses hair, through grooming, washing or molting. Allergens related to Fel-d1, which are also thought to cause an allergic reaction, are shown in Table 1.

Similarly, allergy to dogs is caused by a related protein, Can-d1, and others (Table 1), which are distributed by the dog over its coat when washing.

TABLE 1
Known animal allergen proteins

| Animal | Allergen Protein |
|---|---|
| Domestic cat | Fel-d1 |
| | Fel-d2 |
| | Fel-d3 |
| | Fel-d4 |
| | Fel-d5 |
| | Fel-d6w |
| | Fel-d7w |
| | Fel-d8w |
| Domestic dog | Can-f1 |
| | Can-f2 |
| | Can-f3 |
| | Can-f4 |
| Domestic horse | Equ-c1 |
| | Equ-c2 |
| | Equ-c3 |
| | Equ-c4 |
| | Equ-c5 |
| Guinea pig | Cav-p1 |
| | Cav-p2 |
| Mouse | Mus-m1 |
| Rat | Rat-n1 |

Normally, when an owner grooms or strokes the animal, hair is released into the environment, including the Fel-d1, or Can-d1, or other allergens. This results in a spread of the allergen into the home and can cause further discomfort for the allergic person.

Allergens on an animal's coat are known collectively as dander.

Dander is approximately the same size as bronchial medication droplets and can therefore easily penetrate into bronchial membranes causing the symptoms commonly associated with animal allergies.

Dusters with an electrostatic charge are known in the prior art, which can attract hair and remove an increased amount of hair and dust from the environment than a conventional duster. The disadvantage to this method is that although the allergen is removed from solid objects, such as shelves, tables an can be vacuumed from the carpet or floor, the Fel-d1 or Can-d1 allergens are microscopic and can remain airborne for several hours. In fact, dusting or vacuuming may result in an increased amount of airborne allergen and hence an increased allergic reaction. Furthermore, as the proteins are very sticky, they are not always removed by dusting and vacuuming surfaces.

Alternative solutions of the prior art are cleansers and shampoos for use on the animal, which contain surfactants or detergents to denature the Fel-d1 protein that makes up the majority of the allergens/dander. However, these cleansers or shampoos are wet and animals, especially cats, do not like to be wet. Therefore attempting to clean an animal with such a shampoo may cause distress to the animal and cause difficulty in cleaning the whole animal. It may even cause the animal to mistrust the owner and damage the relationship between owner and animal.

Furthermore, once an animal has been coated with a cleanser, shampoo or even just water, it tends to lick itself “clean” again, rapidly reversing the effects of the shampoo. The “cleaning” by the animal can lead to an increase in the amount of the allergen on the animal's coat.

It is often claimed that regular grooming of the animal will assist in reducing the amount of allergen on its coat. However, although excess hair will be removed, allergen will remain on the hair that is not removed from the animal. Furthermore, grooming will remove the excess hair from the animal, but tends to release the hair into the environment and increase the chance of an allergic reaction.

Although many animals enjoy being groomed, a proportion of animals are frightened of the brush or grooming aid and may attack it. It therefore may not be possible to groom the animal properly. The animal may even become distressed by being groomed.

The problem with the methods of the prior art described above, is that none of them remove the allergen at source and they do not prevent hair and dander being released into the environment.

Another method of the prior art is an ionic brush, which is battery operated and helps to remove excess hair from the animal by a weak electric charge. However, as mentioned above, many animals do not like being groomed by a brush. Therefore, it may be difficult to remove all the excess hair from the animal in this way. Furthermore, as it relies on a battery to be effective, the owner must remember to replace the battery.

Accordingly, there exists a need for a method of reducing the amount of allergen that is in the environment, without causing distress to the animal and without inadvertently increasing the amount of allergen in the environment.

### BRIEF SUMMARY OF THE INVENTION

The present invention is directed to a system and method which provides an electrostatic cloth for use in removing allergens from an animal.

The known methods of reducing environmental allergen levels do not tackle the problem at the source. The present invention is able to remove the allergen from the coat of the animal, before it is spread into the environment.

Furthermore the inventors have found that the use of an electrostatically charged cloth to groom an animal is enjoyable to the animal, as it uses the same action used to stroke an animal. The cloth is held by the owner and a stroking motion is used to stroke the animal from head to tail. The bond between the animal and the owner is enhanced by such an interaction.

The electrostatic charge of the cloth ensures that any loose hair is removed from the coat of the animal together with any dander or allergen particles attached thereto. In addition, allergen particles may also be removed from the animal's coat, leaving the animal with a reduced amount of allergens on its coat and hence, less likely to cause an allergic reaction.

The use of the cloth for grooming therefore removes excess hair and does not release it into the environment and also catches and keeps hold of allergenic particles. The cloth can then be disposed of, preventing the release of the allergens from the cloth into the environment.

A further advantage of removing the excess hair from an animal, is the reduction of hairballs. Hairballs are formed when hair that is ingested by the animal, during washing or grooming, forms into a wad in the stomach of the animal. The animal must then remove the hairball, which often causes the animal to vomit. This is unpleasant for both the animal and the owner. By removing the excess hair from the coat of the animal, the amount of hair ingested by the animal and there fore the risk of hairballs forming, is greatly reduced.

Preferably, the use of the cloth is to groom a companion animal. The companion animal of the present invention is not limited. Companion animals include the domestic cat and the domestic dog, as well as the horse, rabbit, guinea pig, mouse and rat. Preferably, the present invention relates to a cat or a dog. In the present text the term “domestic” dog and “domestic” cat mean dogs and cats in particular Felis domesticus and Canis domesticus.

The present invention relates to the removal of allergens from animals, in particular those set out in Table 1. The major allergen of a cat is Fel-d1, and the major allergen of a dog is Can-d1. Other allergens include Fel-d2 and Fel-d3 and related proteins in both cats and dogs. Accordingly, the present invention preferably relates to Fel-d1 and Can-d1 and related proteins.

In particular, use of the cloth of the present invention to groom the animal will reduce the level of Fel-d1 and related allergens on the coat of the cat or Can-d1 and related allergens on the coat of a dog, and prevent the release of the allergens into the environment.

An electrostatically charged cloth is one that holds a surface charge. The presence of charge means that the cloth will exhibit attractive or repulsive forces. As the cloth comprises an insulating material it is able to hold a surface charge. Some examples of these substances are rubber, plastic, glass and pith. The charge that is transferred in static electricity is stored on the surface of the cloth. Once the cloth is contacted against the coat of an animal, it attracts fine particles, such as hair and allergens. The charge is then discharged and the cloth is no longer electrostatically charged.

Once used, the cloth of the present invention may be discarded, as the electrostatic charge is not as strong. Discarding the cloth after use ensures that all hair captured by the cloth will be disposed of also and not released into the environment. However, it may be possible to re-use the cloth if it is found that the electrostatic charge is still strong enough to attract more hair and allergen from either another animal or if on the same animal after a period of time has elapsed. The charge on the cloth ensures that the hair and allergen already gathered, will not be released into the environment.

The electrostatically charged cloth may assist in cleaning an animal as it may also attract dirt and other particles from the coat of the animal. The electrostatically charged cloth of the present invention may be used to assist in the detection of fleas or other parasites on the animal, as these may be picked up by the cloth and more easily seen by the owner.

The cloth of the present invention may comprise a conditioner. The conditioner may be any that will improve or maintain the condition of an animal's coat. It may be a natural or synthetic conditioner.

The cloth may comprise an active ingredient, such as one to reduce or prevent flea problems. Alternatively or additionally, the active ingredient may be catnip, to increase the willingness of the animal to be groomed. The active ingredient may be natural or synthetic.

The cloth of the present invention may be any fabric or material formed by weaving, knitting, pressing or felting natural or synthetic fibers, that is capable of holding an electrostatic charge. Preferably the cloth is flexible.

The cloth of the present invention may be any shape or size.

The cloth may be in any form such as a mitten or glove. It may being the form of a drawstring “bag,” to be placed over the head of a grooming brush.

A second aspect of the present invention relates to a method for reducing the allergenicity of an animal, the method comprising contacting the animal with an electrostatically charged cloth.

Contacting the animal with the cloth may mean touching the animal at one or more points on the animal's body, or moving the cloth along the length of the animal's body. The movement may be from head to tail, in the direction of the hair growth, or from tail to head. It may also include contacting the sides of the animal's body, at one or more points, or moving the cloth along the length of the flank of the animal. The movement along the length of the animals body may be a stroking motion.

Preferably this movement is repeated several times, to ensure that the majority of the animal has been contacted by the cloth. Most preferably, the method is repeated until no further hair is removed from the coat of the animal, indicating that all excess hair and allergens have been removed from the animal.

The method also has the benefit of increasing interaction between animal and owner and my improve the relationship between them. The animal's trust in the owner may increase, as the method is enjoyable for the animal.

All preferred features of the first aspect of the invention apply to the second aspect.

A third aspect of the invention relates to an animal grooming device comprising an electrostatically charged cloth.

All preferred features of the first and second aspects of the invention apply to the third aspect.

### BRIEF DESCRIPTION OF THE DRAWINGS

The invention will now be described further with reference to the accompanying non-limiting figures, in which:

FIG. 1 shows one embodiment of the present invention;

FIG. 2 shows the method of removal of cat hair from carpet tiles;

FIG. 3 shows the amount of hair collected from the carpet tiles both without grooming and after using an electrostatically charged cloth to groom a cat;

FIG. 4 shows dilutions of neat Fel-d1 standard and Fel-d1 standard spiked and extracted from the electrostatically charged cloth;

FIG. 5 shows Fel-d1 extraction from four samples of cat hair assayed by Western blotting;

FIG. 6 shows Fel-d1 extraction from an electrostatically charged cloth used on one cat; and

FIG. 7 shows Fel-d1 extraction from electrostatic cloth samples used on four different cats.

### DETAILED DESCRIPTION OF THE INVENTION

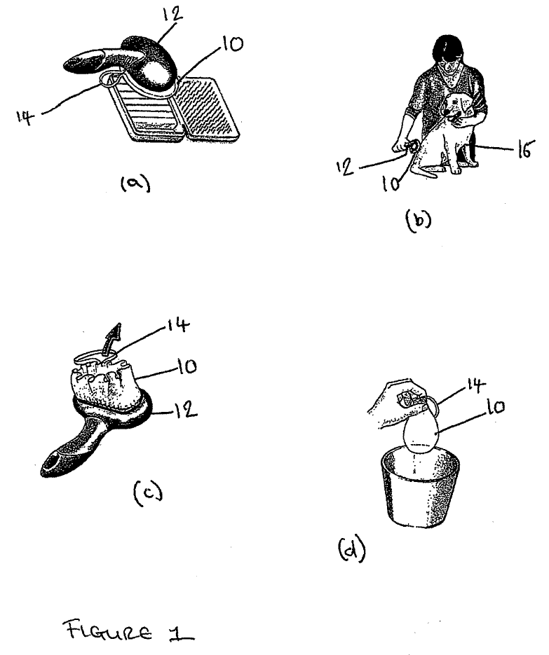

In the embodiment shown in FIG. 1, the cloth 10 is placed over the head of a standard grooming brush 12 and the drawstring 14 tightened to ensure the cloth 10 remains over the head of the brush 12 (a). The brush 12 is then used to groom the animal 16 with the electrostatically charged cloth 10 (b). Once used, the drawstring 14 is loosened and the cloth 10 removed from the head of the brush 12. The cloth 10 is turned inside out, and closed with the drawstring 14 to ensure no hair or allergen is released (c). The cloth 10 is then discarded (d).

The present invention will now be described with reference to the following non-limiting examples.

### Example 1

The experiment was designed to look at the amount of hair shed by a panel of cats being groomed with electrostatically charged cloths over a two-week period.

### Experimental Procedures

### 1. Trial Set-up

### a) Animals, Location and Feeding

The trial was conducted using twelve cats. Each cat was housed in an individual lodge to ensure that the release of hair into the local environment was from one animal only. The lodges were maintained at a temperature of 22° C. with a natural daylight cycle. During the trial period, the cats were maintained on their standard diets and fresh water was available to them at all times.

No changes were made to the cats' normal routine with the exception that all forms of grooming were stopped for the trial period apart from that performed with the electrostatically charged cloths.

Of the cats used in the trial, five were female and seven were male. All were between the ages of six and twelve years.

### b) Trial Design

Carpet Tiles—New carpet tiles were purchased for the experiment. Each carpet tile was cut into the exact size of the cat's bed and placed into the bottom of each bed. All of the carpet tiles were thoroughly vacuumed before being placed into the cat beds to reduce the amount of loose fluff on them.

Training—Each of the twelve cats was placed in a lodge during the week prior to the beginning of the trial. This was to assess whether the cats would use the beds containing the carpet tiles. Had any of the cats appeared not to be using the bed, then they could have been swapped for a different cat from the unit.

Schedule—The trial ran for a total of four weeks. The first two weeks were a control period and the second two weeks a test period. On the first day of the control period a new carpet was placed into the bottom of each of the cats' beds and these placed individually in each lodge. The beds were then left untouched for fourteen days. Following the control period, the carpets were placed in sealed plastic bags before being removed from the lodges.

At the start of the test period, fresh carpet tiles were placed in each lodge in the same locations as used for the control period. Again, they were left untouched for the entire fourteen days. During this period the cats underwent the daily grooming routine described below.

Grooming Procedure—All cats were groomed once daily throughout the test period. A separate fresh electrostatically charged cloth was used on each occasion grooming was performed. Each cloth was folded in half and sewn around the edges to form a loose mitten. Grooming itself consisted of twenty strokes of the cloth over the head region, down the full length of the spine and through to the end of the tail. Following this, the other side of the same mitten was used for a further ten strokes down either flank of the animal. Immediately after grooming, the cloths were placed individually in sealable bags.

Trial Schedule

| Date | Event |
|---|---|
| Day 1 | Carpet mats placed into twelve lodges. |
| Day 15 | Carpet tiles bagged, labeled and removed from |
| | lodges. |
| Day 15 | New carpet tiles placed into lodges. First day |
| | of test grooming schedule. |
| Day 16-28 | Continue daily grooming. |
| Day 29 | Carpet tiles bagged, labeled and removed from |
| | lodges. |
| Day 29 | Cats resume normal grooming schedule. |

### 2. Parameters Measured

Wax strips were used for collecting and measuring the hairs deposited onto the carpets. Alongside this method it was also decided that it would be valuable to assess whether any differences in the levels of hair deposition were evident to the human eye. Before removing and measuring the amount of hair on the carpets, a subjective visual assessment was performed. Having used two of the carpets whilst testing the velvet brush method, the visual assessments and wax strips were performed on ten of the original twelve carpets. The electrostatically charged cloths were also weighed before and after grooming to determine how much hair had stuck to the fabric.

### a) Weighing of Electrostatically Charged Cloths

Prior to grooming, individual electrostatically charged cloths were placed into sealable bags. Each of these was labeled with the cat number and the date and was then weighed. The same bags containing the cloths, after grooming, were then weighed again.

### b) Visual Carpet Assessments

Each cat had two carpets, one from the control period and one from the test period. The carpets were randomly labeled A or B and placed in pairs along a bench in a well-lit area. Thirty seven people took part in the assessments. They were asked to look at all the carpets and decide which carpet, A or B from each pair, appeared to have the most hair.

c) Carpet Hair Removal using Wax Strips

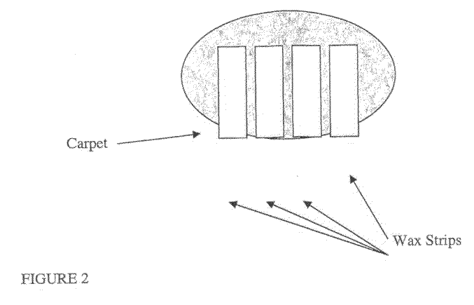

The best method we identified for removing cat hair from the carpets was to use Wax Strips. Four wax strips were used for each carpet. Firstly, the wax strips were placed in a sealable bag, labeled with the cat details, and whether the carpet was from the control or the test period, and weighed. Then, the four wax strips were placed in the same position on each carpet (see FIG. 2) and pressed down firmly by hand.

The wax strips were then removed from the carpet, taking all the cat hair with them and replaced into the sealable bag. Once this had been carried out on all the carpets, the bags containing the wax strips were weighed again. During this process, it was noted that a certain amount of carpet fluff was also collected on the wax strips.

In order to discount the carpet fluff on the wax strips, a small control trial was set up. Two carpets were cut and vacuumed in exactly the same way as the others. Wax strips were used on these carpets, again in exactly the same way as before. The strips were weighed and the mean weight of carpet fluff collected was calculated. This weight could then be deducted from the original strips and allow us to estimate the amount of cat hair alone collected from the carpets.

### Results

### Weighing of Electrostatically Charged Cloths

The mean amount of hair collected each day was 0.017 g with a standard deviation of +/−0.0129.

### Visual Carpet Assessments

Using Kappa's method of agreement, a “fair” result (0.3850 was obtained from the visual assessments.
This agrees with the hypothesis that the use of electrostatically charged cloths reduces the amount of hair distributed onto the carpets.
It was apparent, however, that most of the finer cat hairs appeared to be very similar to the fine carpet hairs, making them difficult to see. Therefore, if this method of assessing hair loss were to be repeated, then cats of a particular color could be selected and a carpet color that contrasted with them could be sued. This way the hairs would be more visible to the human eye.

### Carpet Hair Removal Using Wax Strips

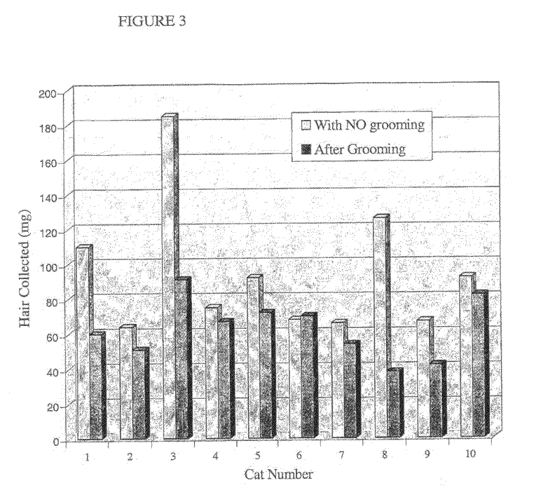

It was found that grooming the cats with a electrostatically charged cloth resulted in a significant reduction in the amount of cat hair distributed onto the carpets (p=0.0163, FIG. 3).
The decrease in the amount of hair distributed onto the carpets after grooming ranged from 10.7% to 69.8%.
In nine out of ten cases there was greater than a 10% decrease in the amount of hair collected. In six of these cases, the decrease was greater than 20%.
From these results it can be seen that the use of an electrostatically charged cloth was effective in reducing the amount of hair released and is therefore likely to reduce the amount of allergen released into the environment.
One of the cats shed more hair (a slight increase of 2.9%) onto the carpet during the test phase than during the control phase. There was no obvious reason as to why this occurred although it could have been due to cat behavior, i.e., spending a greater amount of time lying on the carpet during the test phase than during the control phase.

### Discussion

The trial demonstrated that the use of the electrostatically charged cloth in a grooming regime significantly reduced the amount of hair released into the environment (onto a carpet).
The reduction was seen for nine out of the ten cats tested although with quite a high degree of variability.
The reduction in the deposition of hair was significant enough to be seen by the naked eye using a subjective scoring system.
The subjective scoring system could be improved by pre-selecting carpet color and cat hair colors to improve contrast between the two.

### Additional Observations

Generally, cats appeared to have improved gloss after grooming with an electrostatically charged cloth.

### Conclusion

The results indicate that the grooming of cats with electrostatically charged cloths is an effective means of removing hair and therefore presumably hair-bound allergen.

### Example 2

This experiment was carried out to show that the electrostatically charged cloth is able to remove dander/allergen from an animal.

Before any samples were collected from the test cats, a Western blot was carried out using a sample of the electrostatically charged cloth that had been artificially spike using Fel-d1 standard. This was to investigate if it was possible to detect Fel-d1 from the electrostatic cloth. Four dilutions of the FEl-d1 standard were prepared in phosphate buffered saline (PBS) (Table 1).

TABLE 1
Preparation of Fel-d1 to artificially spike
the electrostatically charged cloth

| Sample | Fel-d1 standard | PBS | Concentration pg/ml |
|---|---|---|---|
| 1 | 1 μl | 0 | 800 |
| 2 | 5 μl | 20 μl | 160 |
| 3 | 5 μl of sample 2 | 20 μl | 32 |
| 4 | 5 μl of sample 3 | 20 μl | 6.4 |

One square of electrostatically charged cloth (8 mm×8 mm) was used per prepared concentration of Fel-d1. Fel-d1 solution (1 μl) was pipetted directly onto the square of cloth and air-dried. The square of cloth was then added to 20 μl of 1× loading buffer. These were set up to assess the level of detection of Fel-d1 from the spiked cloth samples compared to the control samples. This would then give an indication as to how efficiently the Fel-d1 was extracted from the cloth. All samples were put on a hot block at 95° C. for ten minutes to denature the proteins. Samples were then analyzed by Western blotting.

Four cats housed on cat one were used in this trial. Each cat was groomed from head to tail for one minute using an electrostatically charged cloth. Samples were then folded and stored in a sealed plastic bag at room temperature until required.

Western blotting techniques were used to detect Fel-d1 from the electrostatic cloth used to groom the four cats.

### Fel-d1 Extraction

Fel-d1 was extracted from cat hair samples and from the electrostatically charged cloth.
One square of cloth was added to 201 of 1× loading buffer
Samples were put on the hot bock for twenty minutes to denature the proteins.
Samples were centrifuged at 3500 rpm to separate the cloth from the loading buffer.

It was noticed during sample collection that, although all cats were groomed for one minute, some samples contained a far greater amount of Fel-d1 than others. The cloth was examined visually and the amount of cat hair on each sample was taken into consideration when analyzing the electrostatic cloth samples for Fel-d1 allergen. This was to show that grooming a cat using an electrostatic cloth removes allergen from the cat even if a small amount of hair is removed, suggesting that allergen removal occurs without hair removal.

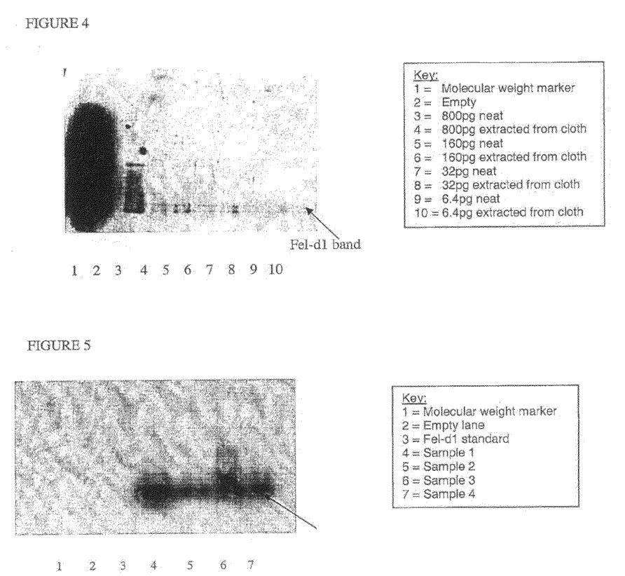

A Western blot was carried out on 9-9-03 using a sample of electrostatic cloth that had been artificially spike with Fel-d1. FIG. 3 clearly shows that Fel-d1 has been extracted from the cloth and detected using a Western blot. The amount of Fel-d1 detected from the electrostatic cloth samples was less than the amount detected in the corresponding spiked samples at all dilutions. This indicates that Fel-d1 recovery from an electrostatic cloth is not 100%. Fel-d1 was detected in all of the diluted samples, indicating that the detection limit fro Fel-d1 by Western blotting in the current assay was 6.4 picograms (pg). It may be possible to detect lower levels of Fel-d1, although further experimental work would be required to determine exact lower detection limits. Multiple band can be seen in Lanes 3, 4, 5 and 6. These bands are due to the Fel-d1 having both glycosylated and un-glycosylated proteins, which separate on the gel as a result of having different molecular weights. The higher bands may also be a result of the proteins not having been fully denatured (see FIG. 4).

Fel-d1 was extracted from four replicate hair samples taken from a large amount of hair removed from a number of cats. This was to prove that Fel-d1 could be extracted from cat hair. Fel-d1 was successfully extracted from the cat hair samples and detected using a Western blot (FIG. 5).

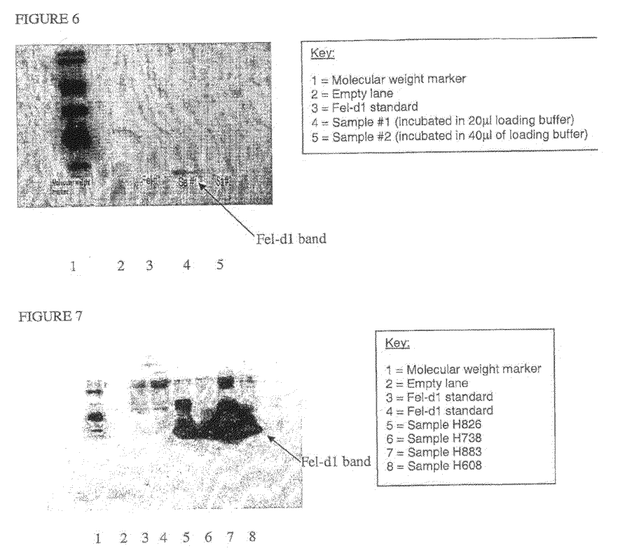

An electrostatic grooming sample was collected initially from one cat. This sample was then used to see if Fel-d1 could be extracted and detected from the hair and dander collected on the cloth (FIG. 6). Two different volumes of loading buffer were investigated for use in the extraction procedure (FIG. 6, Lanes 4 and 5). Samples were incubated on a hot block at 95° C. for ten minutes. Fel-d1 was detected in both samples, although detection levels were greater in sample #1 (FIG. 6, Lane 4). From these results, it is recommended that one square of cloth should be incubated in 20 μl of loading buffer for at least twenty minutes to extract Fel-d1 for detection using Western blotting techniques.

The extraction and detection procedure was repeated using 20 μl of loading buffer with samples from three different cats. The incubation at 95° C. on the hot block was extended to twenty minutes. This was to ensure FEl-d1 extracted from the samples was fully denatured to improve the level of detection on the Western blot (FIG. 7). Fel-d1 was detected with electrostatic cloth samples from all four cats (FIG. 7). The large dark over-exposed area on the Western blot in Lanes 5, 6, 7 and 8 is as a result of the large amount of Fel-d1 that was extracted from each sample. This could be avoided in future assays by diluting the samples before loading it onto the gel or by reducing the exposure time of the film.

### Discussion

Initial experiments using an electrostatic cloth that had been artificially spiked using a Fel-d1 standard, demonstrated that Western blotting was a suitable technique to detect the feline allergen, Fel-d1.
Fel-d1 was detected across a range of concentrations from 6.4 pg-800 pg and was detected in both neat Fel-d1 solutions and from samples of electrostatic cloth that were spiked with Fel-d1. This indicated that Fel-d1 bound onto an electrostatic cloth could be extracted using the extraction procedure detailed and detected using Western blotting techniques.
Fel-d1 was detected from samples of electrostatic cloth that had been sued to groom one cat. This demonstrated that grooming a cat using an electrostatic cloth for one minute does remove enough Fel-d1 to detect using a Western blot.
The extraction and detection procedure was found to be reproducible as Fel-d1 was detected from all four cat samples. It was also possible to detect Fel-d1 from samples of electrostatic cloth that visibly appeared to contain less cat hair, suggesting that the Fel-d1 detected was not present solely on the cat hair removed during grooming. This would suggest that grooming with an electrostatic cloth could remove more Fel-d1 from the coat of a cat than other grooming methods, which rely on removing loose hair, such as combing.

### CONCLUSION

Grooming a cat using an electrostatically charged cloth removes Fel-d1 from the cat. The Fel-d1 removed from the cat can be detected on the electrostatic cloth using Western blotting techniques. Reducing the amount of Fel-d1 on the coat of a cat will make the cat less allergenic to people, suggesting that more people could tolerate the presence of a cat in their home.

1. (canceled)

2. (canceled)

3. (canceled)

4. (canceled)

5. (canceled)

6. (canceled)

7. (canceled)

8. (canceled)

9. A method of reducing the allergenicity of an animal comprising contacting the animal with an electrostatically charged cloth.

10. An animal grooming device comprising an electrostatically charged cloth.

11. The method of claim 9, wherein the animal is a cat or a dog.

12. The method of claim 9, wherein the allergen is Fel-d1, Fel-d2, Fel-d3, Fel-d4, Fel-d5, Fel-d6, Fel-d7, Fel-d8, Can-f1, Can-f2, Can-f3 or Can-f4.

13. The method of claim 9, wherein the cloth further removes one or more of excess hair, dirt, fleas or other parasites.

14. The method of claim 9, wherein the cloth comprises a conditioning agent.

15. The method of claim 9, wherein the cloth comprises natural or synthetic materials, or a mixture thereof.

16. The method of claim 9, wherein the cloth is in the form of a mitten or a glove.

17. The method of claim 9, wherein the cloth is disposable.
